(19) United States
(12) Patent Application Publication
(10) Pub. No.: US 2026/0110851 A1
(43) Pub. Date: Apr. 23, 2026

(54) OPTICAL CONNECTION ASSEMBLY AND METHOD OF MANUFACTURING OPTICAL CONNECTION ASSEMBLY

(71) Applicant: SUMITOMO ELECTRIC INDUSTRIES, LTD., Osaka (JP)

(72) Inventors: Eiichiro YAMADA, Osaka (JP); Tetsuya NAKANISHI, Osaka (JP)

(73) Assignee: SUMITOMO ELECTRIC INDUSTRIES, LTD., Osaka (JP)

(21) Appl. No.: 19/339,411

(22) Filed: Sep. 25, 2025

(30) Foreign Application Priority Data
Oct. 1, 2024 (JP) 2024-172699

(51) Int. Cl. G02B 6/36

(52) U.S. Cl. CPC G02B 6/368

(57) ABSTRACT

An optical connection assembly includes an array conversion component having a first end surface, a second end surface opposite to the first end surface, and a plurality of optical waveguides extending from the first end surface to the second end surface, the plurality of optical waveguides being arrayed in a first direction at the first end surface, an optical waveguide array being formed by two or more of the optical waveguides arrayed in the first direction at the second end surface, and an optical connection component including two or more optical fiber arrays, the two or more optical fiber arrays each including two or more optical fibers and a retaining component on which the two or more optical fibers are arrayed in the first direction, the two or more optical fibers being each connected to a corresponding one of the two or more optical waveguides.

### CROSS REFERENCE TO RELATED APPLICATIONS

This application claims priority based on Japanese Patent Application No. 2024-172699 filed on October 1, 2024, and the entire contents of the Japanese patent application are incorporated herein by reference.

### TECHNICAL FIELD

The present disclosure relates to an optical connection assembly and a method of manufacturing an optical connection assembly.

### BACKGROUND

For example, Patent Literature 1 (WO 2018/135411) discloses an array conversion component that converts a pitch between a plurality of waveguides. By using such an array conversion component, it is possible to connect two optical components (for example, a chip component and an optical fiber) having different pitches between waveguides with low loss.

### SUMMARY

An optical connection assembly according to the present disclosure includes an array conversion component having a first end surface, a second end surface opposite to the first end surface, and a plurality of optical waveguides extending from the first end surface to the second end surface, the plurality of optical waveguides being arrayed in a first direction at the first end surface, an optical waveguide array being formed by two or more of the optical waveguides arrayed in the first direction at the second end surface, the optical waveguide array being arranged in N tiers (where N is an integer that is 2 or greater) in a second direction intersecting the first direction, and an optical connection component including two or more optical fiber arrays, the two or more optical fiber arrays each including two or more optical fibers and a retaining component on which the two or more optical fibers are arrayed in the first direction, the two or more optical fibers being each connected to a corresponding one of the two or more optical waveguides, the two or more optical fiber arrays being arranged in the N tiers in the second direction. Each of center axes of the two or more optical fibers included in the optical fiber array in an n-th tier (where n is an integer that is 2 or greater and that is N or less) is displaced in the first direction from a center axis of a corresponding one of the two or more optical fibers included in the optical fiber array in an (n-1)th tier.

### BRIEF DESCRIPTION OF THE DRAWINGS

FIG. 1 is a perspective view showing an optical connection assembly according to an embodiment.

FIG. 2 is a plan view showing a first end surface of an array conversion component included in the optical connection assembly shown in FIG. 1.

FIG. 3 is a plan view showing a second end surface of an array conversion component included in the optical connection assembly shown in FIG. 1.

FIG. 4 is a front view showing an optical connection component of the optical connection assembly shown in FIG. 1.

FIG. 5 is a perspective view showing a manufacturing step for the optical connection assembly shown in FIG. 1.

FIG. 6 is a front view showing the arrangement of a retaining component in the manufacturing step for the optical connection assembly shown in FIG. 1.

FIG. 7 is a perspective view showing a manufacturing step subsequent to the manufacturing step shown in FIG. 5.

FIG. 8 is a front view showing the arrangement of a retaining component in the manufacturing step shown in FIG. 7.

FIG. 9 is a perspective view showing a manufacturing step subsequent to the manufacturing step shown in FIG. 7.

FIG. 10 is a front view showing the arrangement of a retaining component in the manufacturing step shown in FIG. 9.

FIG. 11 is a perspective view showing a manufacturing step subsequent to the manufacturing step shown in FIG. 9.

FIG. 12 is a front view showing the arrangement of a retaining component in the manufacturing step shown in FIG. 11.

FIG. 13 is a perspective view showing a manufacturing step subsequent to the manufacturing step shown in FIG. 11.

FIG. 14 is a front view showing the arrangement of a retaining component in the manufacturing step shown in FIG. 13.

FIG. 15 is a perspective view showing a manufacturing step subsequent to the manufacturing step shown in FIG. 13.

FIG. 16 is a front view showing the arrangement of a retaining component in the manufacturing step shown in FIG. 15.

FIG. 17 is a perspective view showing a manufacturing step subsequent to the manufacturing step shown in FIG. 15.

FIG. 18 is a front view showing the arrangement of a retaining component in the manufacturing step shown in FIG. 17.

### DETAILED DESCRIPTION

In recent years, with an increase in traffic of a communication network, higher density of transmission paths is required. In order to increase the density of the transmission path, for example, it is conceivable to connect a plurality of optical fibers to a plurality of waveguides of a chip component arrayed at a narrower pitch using the array conversion component as described above. In such a configuration, as the number of optical fibers increases, the width of the plurality of optical fibers in the array direction increases, and the width of the entire product including the array conversion component and the plurality of optical fibers increases.

The present disclosure provides an optical connection assembly and a method of manufacturing the optical connection assembly that can achieve miniaturization while increasing the density of a transmission path.

### [Description of Embodiments of Present Disclosure]

First, the contents of the embodiments of the present disclosure will be listed and described.

(1) An optical connection assembly according to the present disclosure includes an array conversion component having a first end surface, a second end surface opposite to the first end surface, and a plurality of optical waveguides extending from the first end surface to the second end surface, the plurality of optical waveguides being arrayed in a first direction at the first end surface, an optical waveguide array being formed by two or more of the optical waveguides arrayed in the first direction at the second end surface, the optical waveguide array being arranged in N tiers (where N is an integer that is 2 or greater) in a second direction intersecting the first direction, and an optical connection component including two or more optical fiber arrays, the two or more optical fiber arrays each including two or more optical fibers and a retaining component on which the two or more optical fibers are arrayed in the first direction, the two or more optical fibers being each connected to a corresponding one of the two or more optical waveguides, the two or more optical fiber arrays being arranged in the N tiers in the second direction. Each of center axes of the two or more optical fibers included in the optical fiber array in an n-th tier (where n is an integer that is 2 or greater and that is N or less) is displaced in the first direction from a center axis of a corresponding one of the two or more optical fibers included in the optical fiber array in an (n-1)th tier.

The optical connection assembly includes an optical connection component in which two or more optical fiber arrays are arranged in N tiers, the two or more optical fiber arrays each including two or more optical fibers and a retaining component in which the two or more optical fibers are arrayed in a first direction. In this manner, when the optical fiber array is arranged in N tiers, the plurality of optical fibers are arrayed in both the first direction and the second direction, and thus, the width of the optical connection component in the first direction can be reduced as compared with the case where the plurality of optical fibers are arrayed only in the first direction. Further, in the optical connection assembly, each of the center axes of the two or more optical fibers included in the optical fiber array in the n-th tier is displaced in the first direction from each of the center axes of the two or more optical fibers included in the corresponding optical fiber array in the (n-1)th tier. In this case, the optical fibers may be arrayed in the first direction at a higher density by arranging the optical fibers alternately. As a result, even when the pitch between light input-output portions of the connection target component connected to each optical waveguide in the first end surface is made narrower, it is possible to arrange the optical fibers at a high density with a pitch corresponding to the pitch between the light input-output portions. Thus, it is possible to connect the optical fibers of the optical connection component and the light input-output portions of the connection target component at a high density without complicating the paths of the optical waveguides of the array conversion component. Thus, according to the optical connection assembly, it is possible to achieve miniaturization of the optical connection assembly while increasing the density of the transmission path between the optical connection component and the connection target component.

(2) In the optical connection assembly according to the above (1), an amount of displacement of each of the center axes of the two or more optical fibers included in the optical fiber array in the n-th tier in the first direction from the center axis of the corresponding one of the two or more optical fibers included in the optical fiber array in the (n-1)th tier may be smaller than an outer diameter of each of the optical fibers. In this case, since the optical fibers can be arrayed in the first direction at a higher density, the transmission path between the optical connection component and the connection target component can be made denser.

(3) In the optical connection assembly according to the above (1) or (2), a pitch in the first direction between the plurality of optical waveguides arrayed adjacent to each other in the second direction at the second end surface may be identical to a pitch in the first direction between the plurality of optical waveguides at the first end surface. In this case, since each optical waveguide of the array conversion component can be formed as a planar waveguide that changes two-dimensionally inside the array conversion component, the width of the array conversion component in the first direction can be made smaller while suppressing the complexity of the paths of the optical waveguides, compared to a case where a three-dimensional optical waveguide is formed inside the array conversion component. Thus, it is possible to more reliably achieve miniaturization of the optical connection assembly.

(4) In the optical connection assembly according to any one of the above (1) to (3), the two or more optical fiber arrays may be aligned in the first direction. When the optical fiber array includes more optical fibers, the optical fiber array becomes longer in the first direction in accordance with the number of optical fibers. Even in this case, according to the above configuration, an optical fiber array including two or more optical fibers arrayed in the first direction can be formed by combining a plurality of existing retaining components without newly preparing a long retaining component in accordance with the number of optical fibers. Thus, according to the above configuration, the optical connection assembly can be manufactured at low cost using the existing retaining components.

(5) In the optical connection assembly according to the above (4), among the two or more optical fiber arrays, the optical fiber array in the n-th tier may be displaced in the first direction from the optical fiber array in the (n-1)th tier adjacent to the optical fiber array in the n-th tier in the second direction. When the optical fiber array is arranged in a displaced manner, the optical fibers of the optical fiber array and the optical waveguides of the array conversion component can be easily positioned by holding the displaced portion of the optical fiber array by a holding tool while avoiding interference of the holding tool with the optical fiber array in a different tier.

(6) A method of manufacturing an optical connection assembly according to the present disclosure includes preparing an array conversion component and two or more optical fiber arrays, the array conversion component having a first end surface, a second end surface opposite to the first end surface, and a plurality of optical waveguides extending from the first end surface to the second end surface, the plurality of optical waveguides being arrayed in a first direction at the first end surface, an optical waveguide array being formed by two or more of the optical waveguides arrayed in the first direction at the second end surface, the optical waveguide array being arranged in each of N tiers (where N is an integer that is 2 or greater) in a second direction intersecting the first direction, the two or more optical fiber arrays each including two or more optical fibers and a retaining component on which the two or more optical fibers are arrayed in the first direction, aligning in which, in a state in which the optical fiber array in an n-th tier (where n is an integer that is 2 or greater and that is N or less) is held at a position facing the second end surface by a holding tool, the two or more optical fibers included in the optical fiber array in the n-th tier are positioned with respect to the two or more optical waveguides in the n-th tier, and connecting the two or more optical fibers included in the optical fiber array in the n-th tier to the two or more optical waveguides in the n-th tier by fixing the optical fiber array in the n-th tier to the second end surface in a state in which the two or more optical fibers included in the optical fiber array in the n-th tier are positioned with respect to the two or more optical waveguides in the n-th tier. The aligning and the connecting are performed repeatedly in each tier up to the N tiers to arrange the optical fiber arrays in the N tiers in the second direction such that each of center axes of the two or more optical fibers included in the optical fiber array in the n-th tier is displaced in the first direction from a center axis of a corresponding one of the two or more optical fibers included in the optical fiber array in an (n-1)th tier, thereby forming an optical connection component including the optical fiber arrays in the N tiers. According to the method of manufacturing an optical connection assembly, as described above, it is possible to achieve miniaturization of the optical connection assembly while increasing the density of the transmission path between the optical connection component and the connection target component.

(7) In the method of manufacturing an optical connection assembly according to the above (6), in the preparing, the two or more optical fiber arrays aligned in the first direction may be prepared, and, in the aligning, the two or more optical fibers included in the optical fiber array in the n-th tier may be positioned with respect to the two or more optical waveguides in a state in which the optical fiber array in the n-th tier is held by the holding tool so as to be displaced in the first direction from, among the two or more optical fiber arrays, the optical fiber array in the (n-1)th tier adjacent to the optical fiber array in the n-th tier in the second direction. In this case, even when the optical fiber array becomes longer in the first direction in accordance with the number of optical fibers, an optical fiber array including two or more optical fibers arrayed in the first direction can be formed by combining a plurality of existing retaining components without newly preparing a long retaining component in accordance with the number of optical fibers. Thus, according to the above configuration, the optical connection assembly can be manufactured at low cost using the existing retaining components. Further, when the optical fiber array is arranged in a displaced manner as in the above configuration, the optical fibers of the optical fiber array and the optical waveguides of the array conversion component can be easily positioned while avoiding interference of the holding tool with the optical fiber array in a different tier by holding the displaced portion of the optical fiber array by the holding tool.

(8) In the method of manufacturing an optical connection assembly according to the above (7), when the optical fiber array located at a first end of the optical connection component in the first direction is a first optical fiber array, the optical fiber array located at a second end of the optical connection component in the first direction may be an M-th optical fiber array (where M is an integer that is 2 or greater), and the optical fiber array whose amount of displacement toward the second end in the first direction from the optical fiber array that is an (m-1)th optical fiber array is smallest is an m-th optical fiber array (where m is an integer that is 2 or greater and that is M or less), the aligning and the connecting may be performed repeatedly such that the first optical fiber array to the M-th optical fiber array are sequentially held by the holding tool and such that a protruding portion of the m-th optical fiber array is held in the second direction by the holding tool, the protruding portion protruding toward the second end in the first direction with respect to the optical fiber array adjacent to the m-th optical fiber array in the second direction. In this manner, by repeating aligning and connecting for the first to M-th optical fiber arrays so that the protruding portion of the optical fiber array is held by the holding tool in the second direction, it is possible to more reliably prevent the holding tool holding the optical fiber array from interfering with the optical fiber arrays in a different tier. Thus, it is possible to more easily position the optical fibers of the optical fiber array and the optical waveguides of the array conversion component.

### DETAILS OF EMBODIMENTS OF PRESENT DISCLOSURE

Specific examples of an optical connection assembly and a method of manufacturing an optical connection assembly of the present disclosure will be described in detail below with reference to the accompanying drawings. The present invention is not limited to these examples, but is defined by the scope of the claims, and is intended to include all modifications within the meaning and scope equivalent to the scope of the claims. In the description of the drawings, the same elements are denoted by the same reference numerals, and redundant description will be omitted as appropriate.

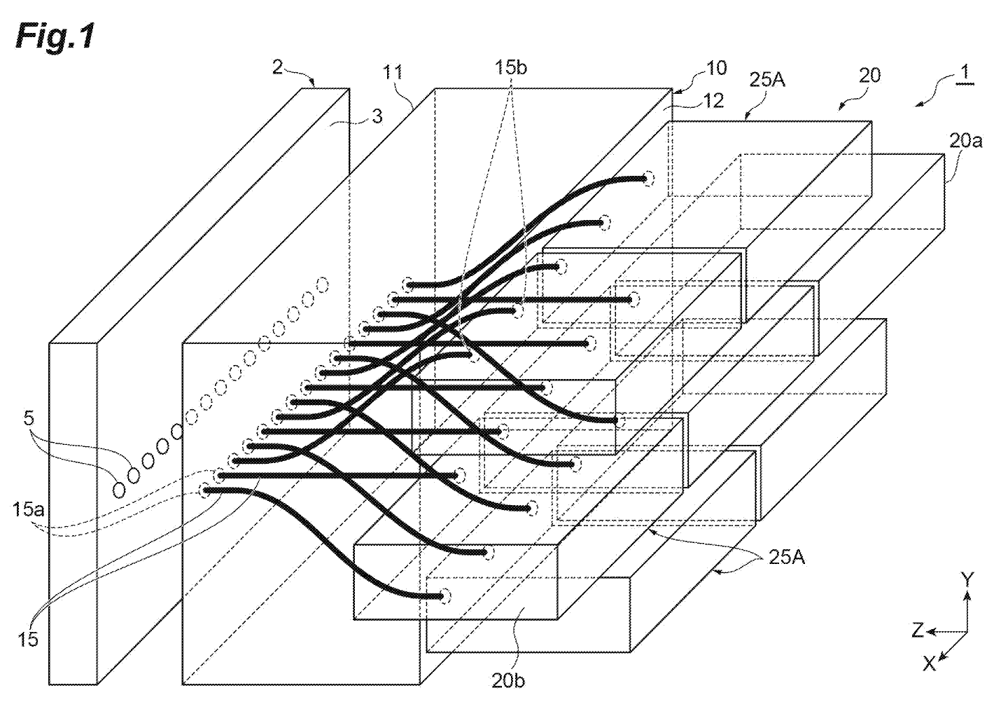

As shown in FIG. 1, an optical connection assembly 1 includes an array conversion component 10 and an optical connection component 20. In FIG. 1, an XYZ orthogonal coordinate system is shown for easy understanding. An X direction (first direction), a Y direction (second direction), and a Z direction intersect (for example, are orthogonal to) each other. The array conversion component 10 has, for example, a rectangular parallelepiped shape, and includes a first end surface 11, a second end surface 12 opposite to the first end surface 11, and a plurality of optical waveguides 15 extending from the first end surface 11 to the second end surface 12.

The first end surface 11 and the second end surface 12 are, for example, planes extending along the X direction and the Y direction, and are arranged along the Z direction. In one example, the first end surface 11 and the second end surface 12 are parallel to each other, and the respective normal directions of the first end surface 11 and the second end surface 12 are coincident with each other. A first end 15a of each of the plurality of optical waveguides 15 is located on the first end surface 11. A second end 15b of each of the plurality of optical waveguides 15 is located on the second end surface 12. The array of the first ends 15a of the optical waveguides 15 in the first end surface 11 is different from the array of the second ends 15b of the optical waveguides 15 in the second end surface 12. The array conversion component 10 converts the array of the first ends 15a of the optical waveguides 15 into the array of the second ends 15b of the optical waveguides 15.

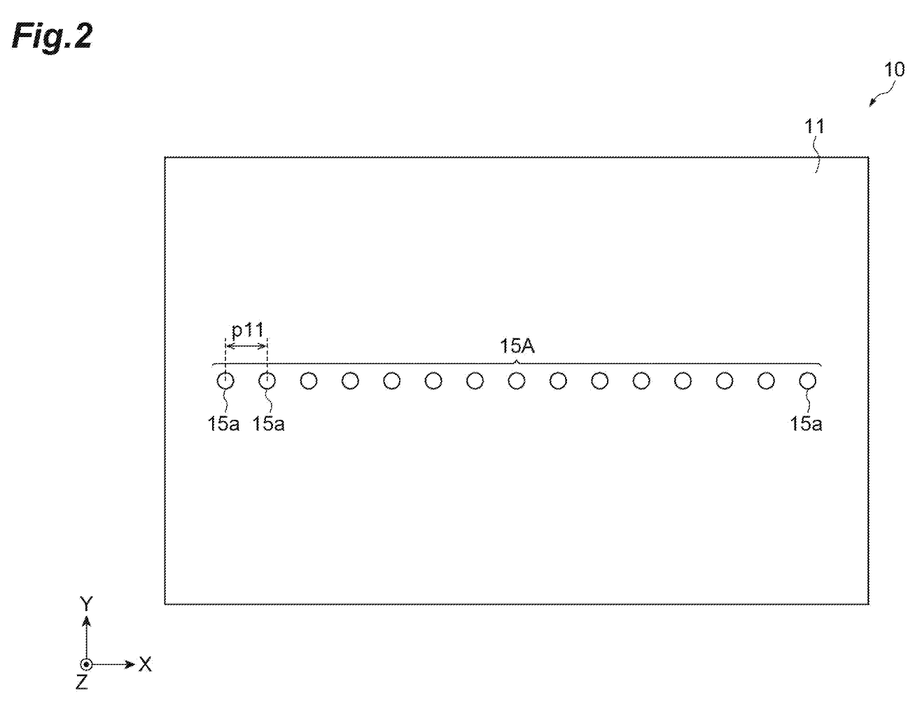

As shown in FIG. 2, the first ends 15a of the optical waveguides 15 are arrayed in a line along the X direction on the first end surface 11. The first ends 15a of the optical waveguides 15 are arrayed at equal intervals along the X direction, for example. A pitch p11 between the first ends 15a of the optical waveguides 15 in the X direction is, for example, less than 80 μm. The pitch p11 between the first ends 15a of the optical waveguides 15 in the X direction is a distance between the centers of the first end 15a of two optical waveguides 15 adjacent to each other in the X direction. The first ends 15a of the plurality of optical waveguides 15 arrayed in a line along the X direction form an optical waveguide array 15A. The optical waveguide array 15A may be arranged in two or more tiers in the Y direction.

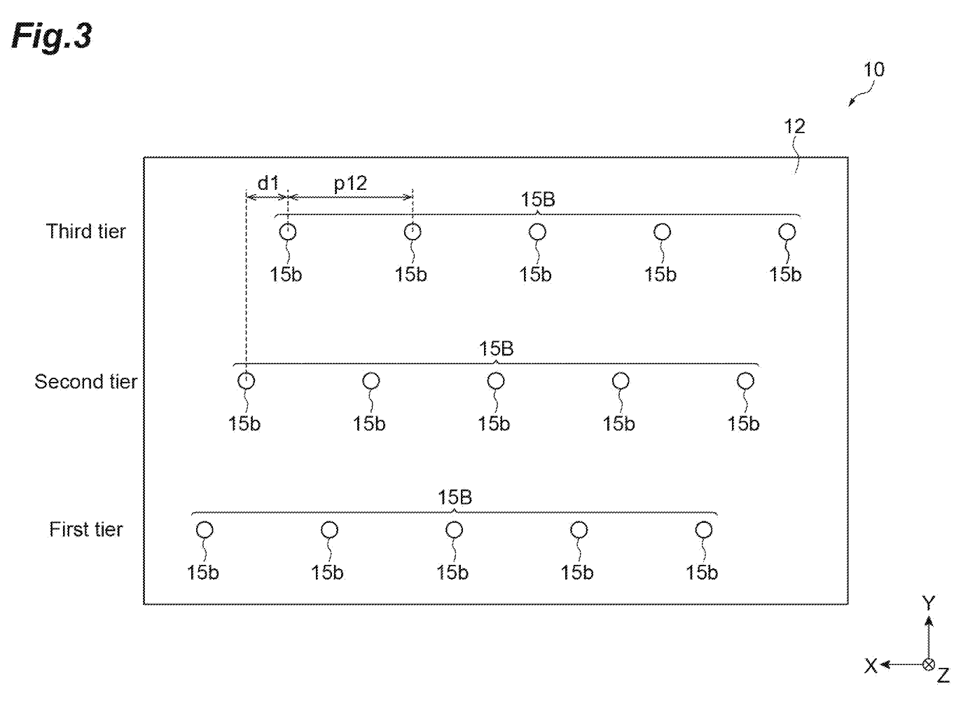

As shown in FIG. 3, the second ends 15b of the optical waveguides 15 are arrayed along the X direction and the Y direction on the second end surface 12. The second ends 15b of two or more optical waveguides 15 arrayed in a line along the X direction form an optical waveguide array 15B. The optical waveguide array 15B is arranged in N tiers (where N is an integer that is 2 or greater) along the Y direction. In the embodiment, the optical waveguide array 15B in three tiers (N = 3) is formed along the Y direction. The number of tiers of the optical waveguide array 15B is not limited to three, and may be two, or four or more.

The optical waveguides 15 forming the optical waveguide array 15B are arrayed at equal intervals along the X direction, for example. A pitch p12 between the second ends 15b of the optical waveguides 15 in the X direction is, for example, 80 μm or more. The pitch p12 between the second ends 15b of the optical waveguides 15 may be 125 μm or more, or may be 250 μm or more. The pitch p12 between the second ends 15b of the optical waveguides 15 is a distance between the centers of the second ends 15b of two optical waveguides 15 adjacent to each other in the X direction in the optical waveguide array 15B.

The center of each optical waveguide 15 included in the optical waveguide array 15B in an n-th tier (where n is an integer that is 2 or greater and that is N or less) of the N tiers is arranged so as to be displaced in the X direction from the center of each optical waveguide 15 included in the optical waveguide array 15B in an (n-1)th tier. That is, the center of each optical waveguide 15 in the n-th tier is arranged alternately in the X direction with respect to the center of each optical waveguide 15 in the (n-1) th tier. In one example, centers of all the optical waveguides 15 in the second tiers or more are arranged so as to be displaced in the X direction from the center of each optical waveguide 15 in the first tier.

An amount of displacement d1 in the X direction of the optical waveguide 15 in the n-th tier from the optical waveguide 15 in the (n-1)th tier is smaller than the pitch p12 between the second ends 15b of the optical waveguides 15 in the X direction. The amount of displacement d1 of the optical waveguide 15 in the n-th tier from the optical waveguide 15 in the (n-1)th tier is a distance in the X direction between the center of the optical waveguide 15 in the n-th tier and the center of the optical waveguide 15 in the (n-1)th tier. The amount of displacement d1 corresponds to the pitch in the X direction between the optical waveguides 15 adjacent to each other in the Y direction. The pitch (i.e., the amount of displacement d1) in the X direction between the optical waveguides 15 adjacent to each other in the Y direction is, for example, identical to the pitch p11 between the first ends 15a of the optical waveguides 15 in the X direction. In this case, each optical waveguide 15 extending from the first end surface 11 to the second end surface 12 forms a two-dimensional planar waveguide extending along the Y direction and the Z direction. The path of each optical waveguide 15 forming a planar waveguide varies in the plane along the Y and Z directions, without varying in the X direction.

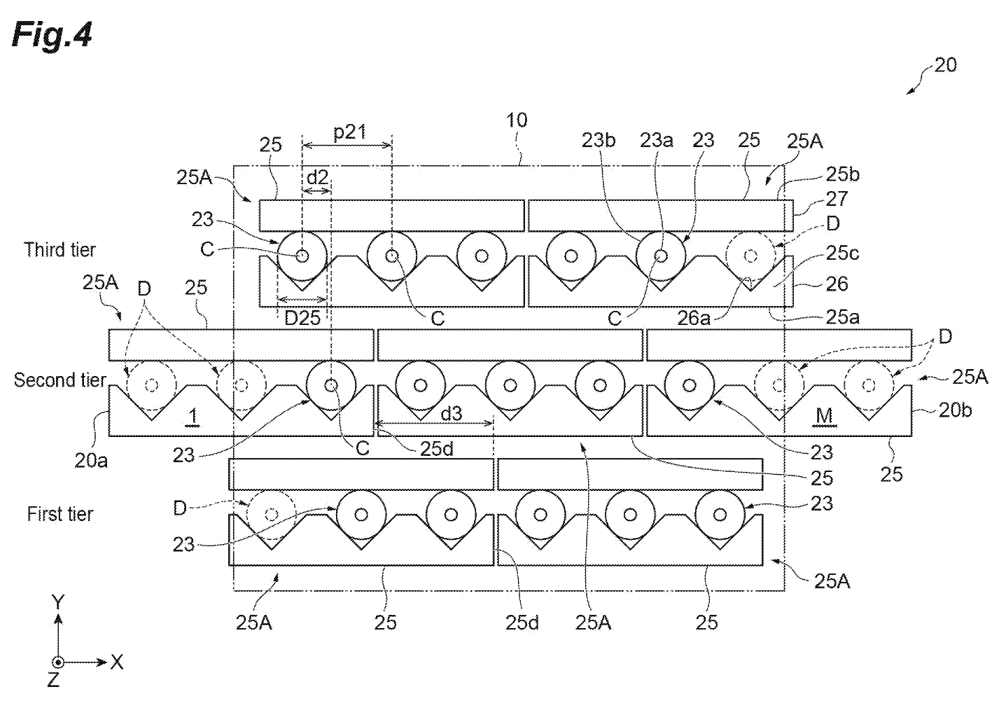

As shown in FIG. 4, the optical connection component 20 includes a plurality of optical fibers 23 and a plurality of retaining components 25. Each of the plurality of optical fibers 23 is, for example, a single-core fiber, but may be a multicore fiber or another optical fiber. When each optical fiber 23 is a single-core fiber, each optical fiber 23 includes a glass fiber 23b having a core 23a at a center axis C. The glass fiber 23b is surrounded by a resin coating. The tip end of the glass fiber 23b is exposed from the resin coating. The outer diameter of the glass fiber 23b is, for example, 125 μm. The outer diameter of the resin coating surrounding the glass fiber 23b is, for example, 250 μm. The outer diameter of the glass fiber 23b corresponds to an outer diameter D25 of the optical fiber 23 retained by the retaining component 25.

The plurality of optical fibers 23 are arrayed along the X direction and the Y direction so as to correspond to the array of the second ends 15b of the optical waveguides 15 described above. Two or more optical fibers 23 arrayed in a line along the X direction and the retaining component 25 that retains the two or more optical fibers 23 arrayed in a line along the X direction form an optical fiber array 25A. That is, the optical fiber array 25A includes two or more optical fibers 23 and the retaining component 25 in which the two or more optical fibers 23 are arrayed in a line along the X direction. The optical fiber array 25A is arrayed in a line along the X direction. The optical fiber array 25A is arranged in N tiers along the Y direction. In the embodiment, the optical fiber array 25A in three tiers (N = 3) is formed along the Y direction. The number of tiers of the optical fiber array 25A is not limited to three, and may be two, or may be four or more. The optical fiber array 25A may be formed by arranging one optical fiber 23 in the retaining component 25. That is, the optical fiber array 25A may include one optical fiber 23 and one retaining component that retains the one optical fiber 23.

The optical fibers 23 forming the optical fiber array 25A are arrayed at equal intervals along the X direction, for example. A pitch p21 between the optical fibers 23 in the X direction is, for example, 80 μm or more. The pitch p21 between the optical fibers 23 is identical to the pitch p12 between the second ends 15b of the optical waveguides 15 (see FIG. 3). The pitch p21 between the optical fibers 23 may be, for example, 125 μm or more, or may be 250 μm or more. The pitch p21 between the optical fibers 23 is a distance between the center axes C of two optical fibers 23 adjacent to each other in the X direction in the optical fiber array 25A.

The center axis C of each optical fiber 23 included in the optical fiber array 25A in the n-th tier is arranged so as to be displaced in the X direction from the center axis C of each optical fiber 23 included in the optical fiber array 25A in the corresponding (n-1)th tier. That is, the center axis C of each optical fiber 23 in the n-th tier is arranged alternately in the X direction with respect to the center axis C of each optical fiber 23 in the corresponding (n-1)th tier. The optical fiber 23 corresponding (n-1)th tier means optical fiber 23 in the (n-1)th having the smallest amount of displacement d2 in the X direction from the n-th tier. For example, the center axes C of all the optical fibers 23 in the second tiers or more are arranged so as to be displaced in the X direction from the center axis C of each optical fiber 23 in the first tier. An amount of displacement d2 in the X direction of the optical fiber 23 in the n-th tier from the optical fiber 23 in the (n-1)th tier corresponds to the pitch (for example, the distance between the center axes C) in the X direction between the optical fiber 23 adjacent to each other in the Y direction. The amount of displacement d2 is smaller than the pitch p21 between the optical fibers 23 in the n-th tier, and is smaller than, for example, the outer diameter D25 of the glass fiber 23b. For example, the amount of displacement d2 (i.e., the pitch in the X direction between the optical fiber 23 adjacent to each other in the Y direction) is identical to the pitch p11 (see FIG. 2) between the first ends 15a of the optical waveguides 15 in the X direction, for example.

One retaining component 25 forming the optical fiber array 25A includes a support portion 26 supporting two or more optical fibers 23 and a cover portion 27 covering the support portion 26 with the two or more optical fibers 23 interposed between the support portion 26 and the cover portion 27. For example, the glass fibers 23b of two or more optical fibers 23 are placed on two or more V-grooves 26a formed in the support portion 26, and the cover portion 27 is arranged to cover two or more glass fibers 23b. The optical fiber array 25A includes, in addition to the retaining component 25 in which the optical fibers 23 are placed on all the V-grooves 26a, the retaining component 25 in which the optical fibers 23 and dummy fibers D that do not contribute to light guiding are placed on the V-grooves 26a. The dummy fiber D does not necessarily have to be placed on the V-groove 26a of the retaining component 25. That is, the optical fiber 23 contributing to light guiding may be placed on all the V-grooves 26a of the retaining component 25. A bottom surface of the support portion 26 forms a lower end surface 25a of the retaining component 25. A top surface of the cover portion 27 forms an upper end surface 25b of the retaining component 25. A front end surface of each of the support portion 26 and the cover portion 27 forms a front end surface 25c of the retaining component 25. The lower end surface 25a is an end surface located at the first end of the retaining component 25 in the Y direction. The upper end surface 25b is an end surface located at the second end of the retaining component 25 in the Y direction. The front end surface 25c is an end surface located at an end of the retaining component 25 in the Z direction.

The optical fiber array 25A in the n-th tier is arranged to be displaced in the X direction from the optical fiber array 25A in the (n-1)th tier adjacent to the optical fiber array 25A in the n-th tier in the Y direction. To be specific, the retaining component 25 of the optical fiber array 25A in the n-th tier is arranged so as to be displaced in the X direction from the retaining component 25 of the optical fiber array 25A in the (n-1)th tier adjacent to the retaining component 25 of the optical fiber array 25A in the n-th tier in the Y direction. That is, a side end surface 25d of the retaining component 25 of each optical fiber array 25A in the n-th tier in the X direction protrudes in the X direction or is recessed in the X direction with respect to the side end surface 25d of the retaining component 25 of each optical fiber array 25A in the (n-1)th tier. FIG. 4 shows an amount of displacement d3 of the optical fiber array 25A in the n-th tier from the optical fiber array 25A in the (n-1)th tier. The amount of displacement d3 is a distance in the X direction between the side end surface 25d of the retaining component 25 in the optical fiber array 25A in the (n-1)th tier and the side end surface 25d of the retaining component 25 in the optical fiber array 25A in the n-th tier. The boundary position of two optical fiber arrays 25A adjacent to each other in the X direction is arranged so as to be displaced in the X direction in each tier. The boundary position is, for example, the center position of the gap between two retaining components 25 adjacent to each other in the X direction.

Reference is again made to FIG. 1. As shown in FIG. 1, each optical fiber array 25A is arranged so that the front end surface 25c faces the second end surface 12 of the array conversion component 10. The optical fiber 23 included in each optical fiber array 25A is arranged to face the second end 15b of the optical waveguide 15 at the second end surface 12 and is connected to the optical waveguide 15. The retaining component 25 and the optical fiber 23 in the optical fiber array 25A are fixed to the second end surface 12 with, for example, an ultraviolet-curable adhesive. A connection target component 2 to be connected to the optical connection component 20 is arranged in the first end surface 11 of the array conversion component 10. Although FIG. 1 shows a state in which the optical connection component 20 and the connection target component 2 are arranged with a slight gap with respect to the array conversion component 10, the optical connection component 20 and the connection target component 2 may be in contact with the array conversion component 10 without a gap.

The connection target component 2 is, for example, a chip component such as a silicon photonics chip. The connection target component 2 includes, for example, a main surface 3 on which a plurality of light input-output portions 5 are mounted. The main surface 3 is, for example, a surface extending along the X direction, and is arranged to face the first end surface 11 of the array conversion component 10. The light input-output portions 5 are arranged in a line in the X direction on the main surface 3, and the light input-output portions 5 are arranged on the first end surface 11 to face the first ends 15a of the optical waveguides 15 and are connected to the optical waveguides 15. The pitch between the light input-output portions 5 in the X direction is identical to the pitch p11 (referring to FIG. 2) between the first ends 15a of the optical waveguides 15 in the X direction, for example, 80 μm or less. The pitch between the light input-output portions 5 in the X direction is a distance between centers of two light input-output portions 5 adjacent to each other in the X direction.

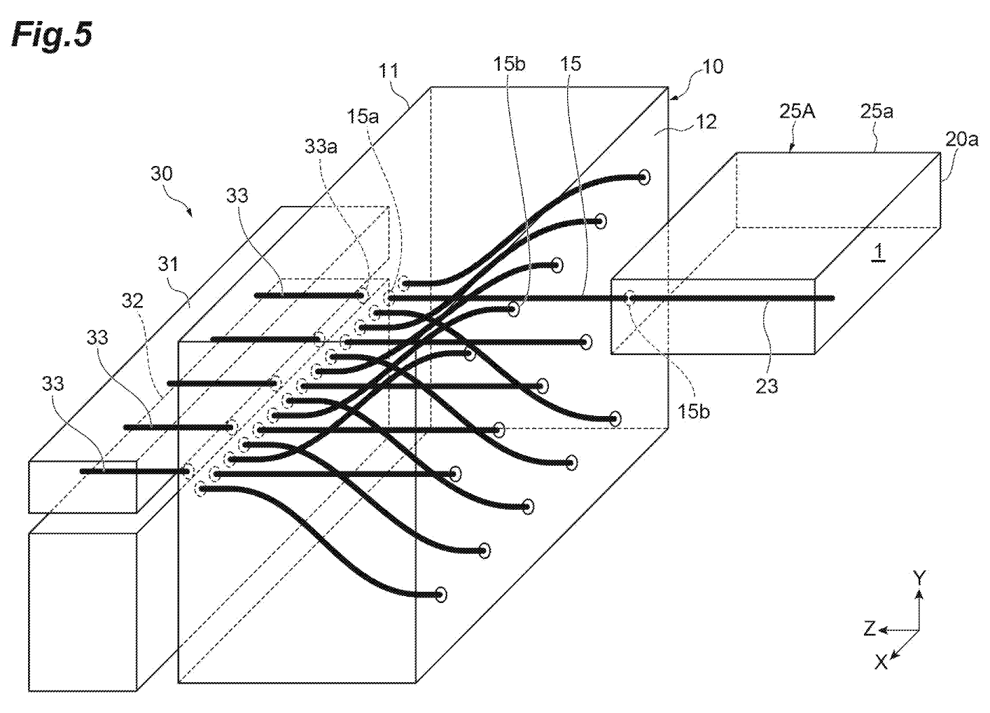

Referring to FIGS. 5 to 18, a method of manufacturing the optical connection assembly 1 of the embodiment will be described.

First, in addition to the array conversion component 10 and the optical connection component 20 described above, an alignment component 30 shown in FIG. 5 is prepared (preparing). The alignment component 30 is an alignment component used for determining the position of the optical fiber 23 of the optical connection component 20 with respect to the optical waveguide 15 of the array conversion component 10. The alignment component 30 includes a plurality of alignment fibers 33, a cover portion 31, and a support portion 32. The alignment fibers 33 are arrayed in a line along the X direction at a pitch wider than the pitch p11 (see FIG. 2) between the first ends 15a of the optical waveguides 15 in the first end surface 11. Each alignment fiber 33 is supported by the support portion 32 and covered by the cover portion 31.

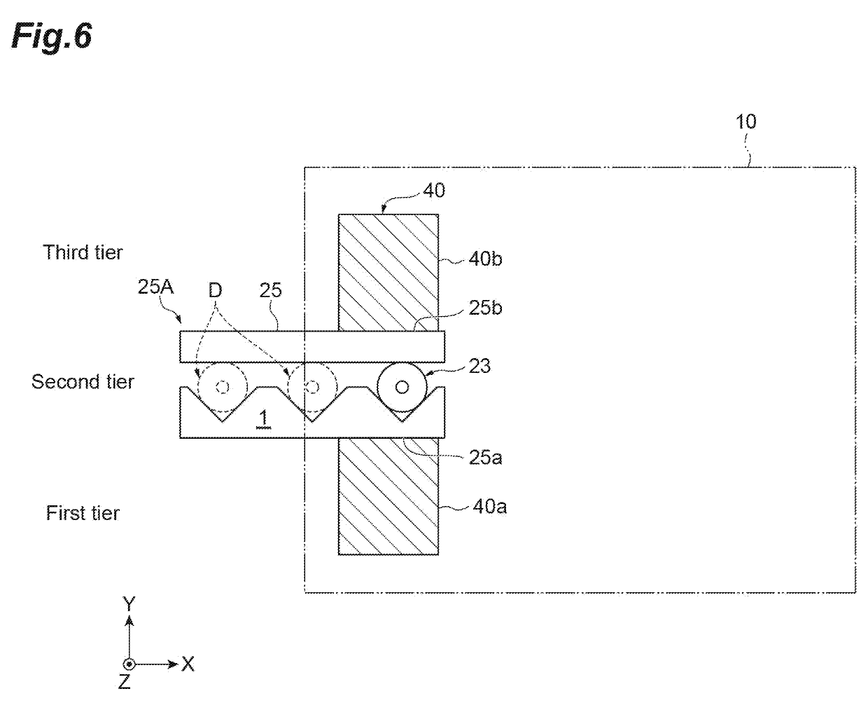

The alignment component 30 is arranged to face the first end surface 11 of the array conversion component 10. The second end surface 12 of the array conversion component 10 is arranged to face the optical fiber array 25A of the optical connection component 20. The optical fiber array 25A includes one or more optical fibers 23. The optical fiber array 25A faces the second end surface 12 in a state where the optical fiber array 25A is held by a holding tool 40 (see FIG. 6). The optical fiber 23 included in the optical fiber array 25A is arranged to face the second end 15b of the optical waveguide 15 of the second end surface 12, and is positioned (aligned) with respect to the optical waveguide 15 (aligning). Then, the optical fiber array 25A (in detail, the retaining component 25 that retains the optical fiber 23) is fixed to the array conversion component 10 with an adhesive, and the optical fiber 23 is connected to the optical waveguide 15 of the array conversion component 10 (connecting).

The aligning and the connecting described above are repeatedly performed for each retaining component 25. For example, when the optical fiber array 25A located at a first end 20a of the optical connection component 20 in the X direction is a first optical fiber array 25A, the optical fiber array 25A located at a second end 20b of the optical connection component 20 in the X direction is an M-th optical fiber array 25A (where M is an integer that is 2 or greater), and the optical fiber array 25A whose amount of displacement d3 toward the second end 20b in the X direction from an (m-1)th optical fiber array 25A is smallest is an m-th optical fiber array 25A (where m is an integer that is 2 or greater and that is M or less), the aligning and the connecting are repeatedly performed for each optical fiber array 25A such that the first optical fiber array 25A to the M-th optical fiber array 25A are sequentially held by the holding tool 40 (see FIG. 4).

The m-th optical fiber array 25A is the optical fiber array 25A arranged at a position adjacent to the (m-1)th optical fiber array 25A in the Y direction in a different tier from the (m-1)th optical fiber array 25A. The amount of displacement d3 of the m-th optical fiber array 25A from the (m-1)th optical fiber array 25A means a distance in the X direction between the side end surface 25d of the retaining component 25 of the (m-1)th optical fiber array 25A and the side end surface 25d of the retaining component 25 of the m-th optical fiber array 25A.

Hereinafter, a method of manufacturing the optical connection assembly 1 including the aligning and the connecting described above will be described in more detail.

First, as shown in FIGS. 5 and 6, the first optical fiber array 25A is arranged on the second end surface 12 of the array conversion component 10. Then, in a state in which the alignment component 30 is spaced apart from the first end surface 11 in the Z direction, the alignment fiber 33 is roughly positioned (roughly aligned) with respect to the optical waveguide 15 to which the optical fiber 23 included in the first optical fiber array 25A is to be connected, for example, using image processing.

Next, in a state where the first optical fiber array 25A is held by the holding tool 40, the first optical fiber array 25A is arranged at a position spaced apart from the second end surface 12 in the Z direction. In this state, the optical fiber 23 included in the first optical fiber array 25A is roughly positioned (roughly aligned) with respect to the optical waveguide 15 to be connected, for example, using image processing. The first optical fiber array 25A is located, for example, in the second tier, but may be located in the first tier or in the third tier. Here, the holding tool 40 shown in FIG. 6 is, for example, a chuck, and includes a pair of holding portions 40a and 40b that sandwich the optical fiber array 25A in the Y direction. A first holding portion 40a is in contact with the lower end surface 25a of the retaining component 25 of the optical fiber array 25A, and a second holding portion 40b is in contact with the upper end surface 25b of the retaining component 25 of the optical fiber array 25A.

Next, the alignment fiber 33, the optical waveguide 15, and the optical fiber 23 are precisely positioned with respect to each other. For example, the measurement light is incident on the alignment fiber 33, the optical waveguide 15, and the optical fiber 23. Then, the positions of the alignment fiber 33, the optical waveguide 15, and the optical fiber 23 are adjusted so that the coupling efficiency of the measurement light is maximized (peak search alignment). Thus, the alignment fiber 33, the optical waveguide 15, and the optical fiber 23 are positioned with respect to each other with high accuracy.

Next, the first optical fiber array 25A is temporarily retracted, and a predetermined amount of ultraviolet-curing adhesive is applied to the second end surface 12. Thereafter, the first optical fiber array 25A is returned to the original position (i.e., the position where the optical fiber array 25A is positioned with high accuracy). At this time, the adhesive spreads uniformly between the second end surface 12 and the optical fiber array 25A. Thereafter, the adhesive is irradiated with ultraviolet rays for a predetermined time, whereby the adhesive is cured. Thus, the first optical fiber array 25A is fixed to the second end surface 12, and the optical fiber 23 of the first optical fiber array 25A is connected to the optical waveguide 15 to be connected. Then, the first optical fiber array 25A fixed to the second end surface 12 is released from the holding tool 40.

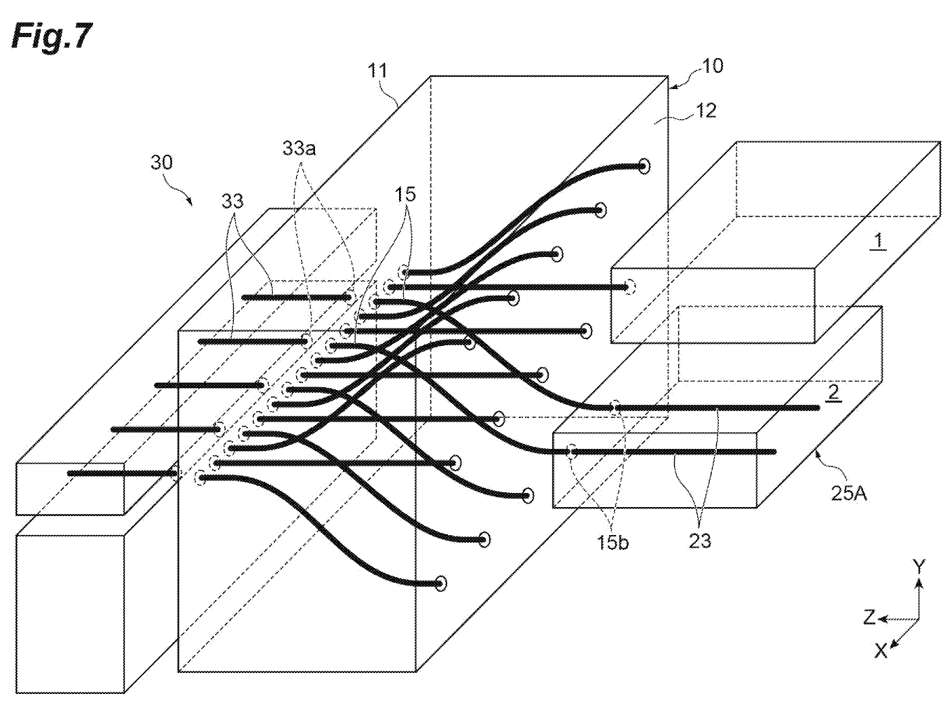

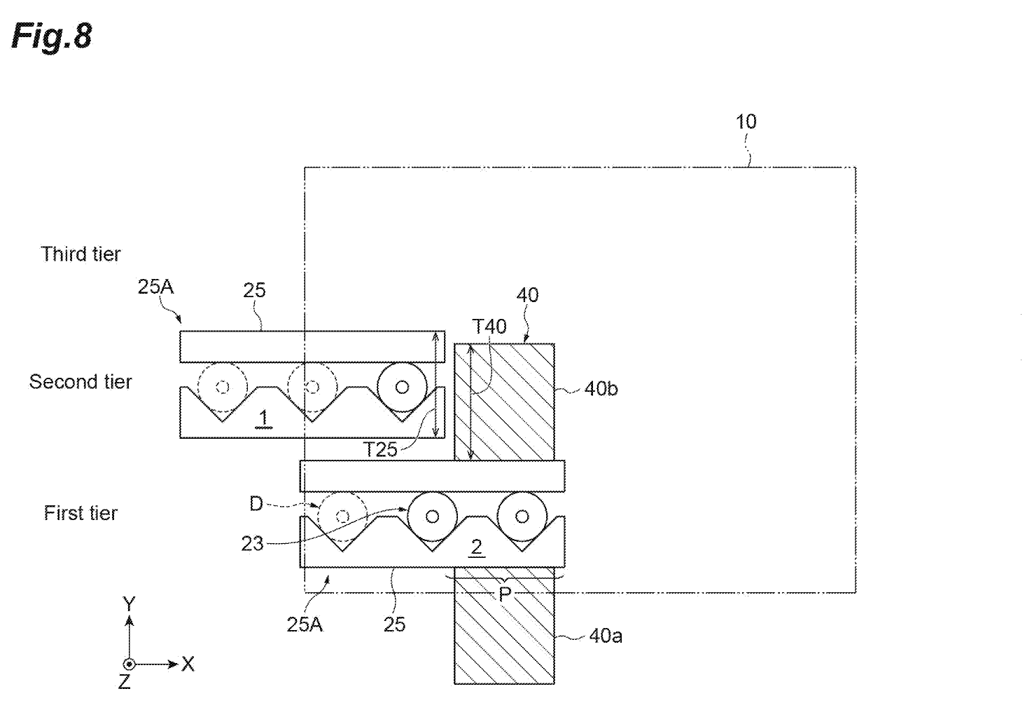

Next, as shown in FIGS. 7 and 8, the second optical fiber array 25A is arranged on the second end surface 12 of the array conversion component 10. The second optical fiber array 25A is arranged in the first tier of the N tiers, for example. Thus, the second optical fiber array 25A is arranged in a different tier from the first optical fiber array 25A. The second optical fiber array 25A is adjacent to the first optical fiber array 25A in the Y direction, and is displaced from the first optical fiber array 25A so as to protrude toward the second end 20b (see FIG. 4) in the X direction.

In a state in which the alignment component 30 is spaced from the first end surface 11 in the Z direction, the two alignment fibers 33 are roughly positioned (roughly aligned) with respect to the two optical waveguides 15 to which the two optical fibers 23 included in the second optical fiber array 25A are to be connected, for example, using image processing.

Next, in a state where the second optical fiber array 25A is held by the holding tool 40, the second optical fiber array 25A is arranged at a position spaced apart from the second end surface 12 in the Z direction. As shown in FIG. 8, the holding tool 40 holds a protruding portion P of the second optical fiber array 25A protruding in the X direction with respect to the first optical fiber array 25A in the Y direction. A thickness T40 of each of the holding portions 40a and 40b in the Y direction is equal to or less than a thickness T25 of the retaining component 25 in the Y direction. In a state where the second optical fiber array 25A is held by the holding tool 40, two optical fibers 23 retained in the second optical fiber array 25A are roughly positioned (roughly aligned) with respect to the two optical waveguides 15 to be connected, for example, using image processing.

Next, the two alignment fibers 33, the two optical waveguides 15, and the two optical fiber 23 are precisely positioned with respect to each other. For example, the measurement light is incident on a first alignment fiber 33 of the two alignment fibers 33, a first optical waveguide 15 of the two optical waveguides 15, and a first optical fiber 23 of the two optical fibers 23. Then, the first alignment fiber 33, the first optical waveguide 15, and the first optical fiber 23 are aligned with each other so that the coupling efficiency of the measurement light is maximized (peak search alignment). Thus, the first alignment fiber 33, the first optical waveguide 15, and the first optical fiber 23 are positioned with respect to each other with high accuracy. At this time, the position of the first optical fiber 23 with respect to the array conversion component 10 is recorded.

Next, the measurement light is incident on a second alignment fiber 33 of the two alignment fibers 33, a second optical waveguide 15 of the two optical waveguides 15, and a second optical fiber 23 of the two optical fibers 23. Then, the second alignment fiber 33, the second optical waveguide 15, and the second optical fiber 23 are aligned with each other so that the coupling efficiency of the measurement light is maximized (peak search alignment). Thus, the second alignment fiber 33, the second optical waveguide 15, and the second optical fiber 23 are aligned with each other. At this time, the position of the second optical fiber 23 with respect to the array conversion component 10 is recorded.

Next, the recorded position of the first optical fiber 23 and the recorded position of the second optical fiber 23 are compared, and the rotation amount of the optical fiber array 25A required to align these positions with the reference position is calculated. In the case where the rotation amount is outside the allowable range, the above-described peak search alignment is performed again. When the calculated rotation amount is within the allowable range, the second optical fiber array 25A is temporarily retracted, and a predetermined amount of ultraviolet-curing adhesive is applied to the second end surface 12. Thereafter, the second optical fiber array 25A is returned to the original position (i.e., the position where the optical fiber array 25A is positioned with high accuracy).

At this time, the adhesive spreads uniformly between the second end surface 12 and the optical fiber array 25A. Thereafter, the adhesive is irradiated with ultraviolet rays for a predetermined time, whereby the adhesive is cured. Thus, the second optical fiber array 25A is fixed to the second end surface 12, and each optical fiber 23 of the second optical fiber array 25A is connected to each optical waveguide 15 to be connected. Then, the second optical fiber array 25A fixed to the second end surface 12 is released from the holding tool 40.

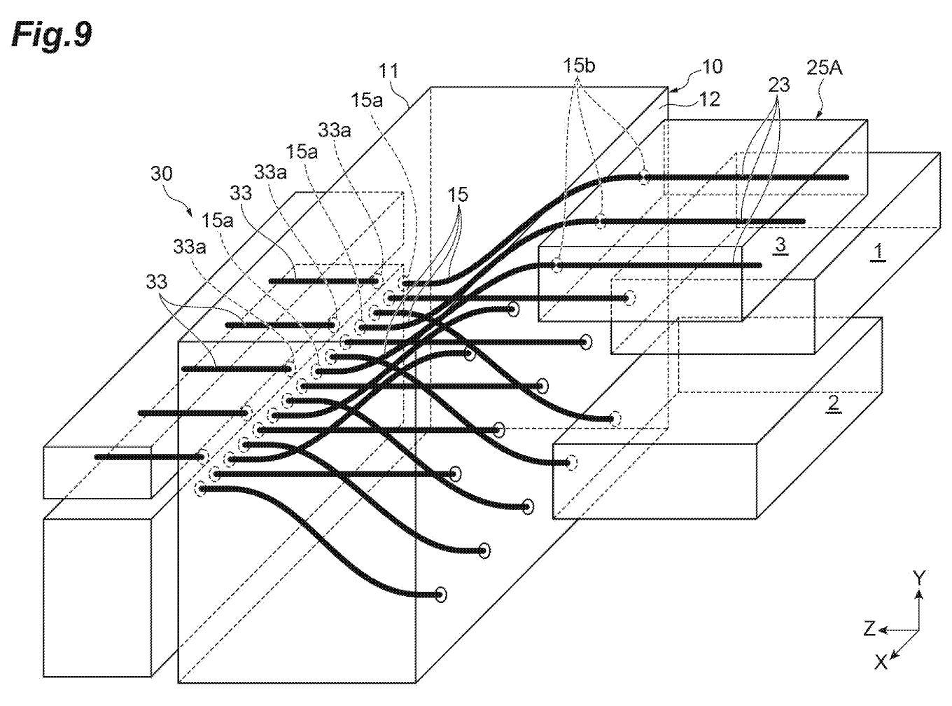

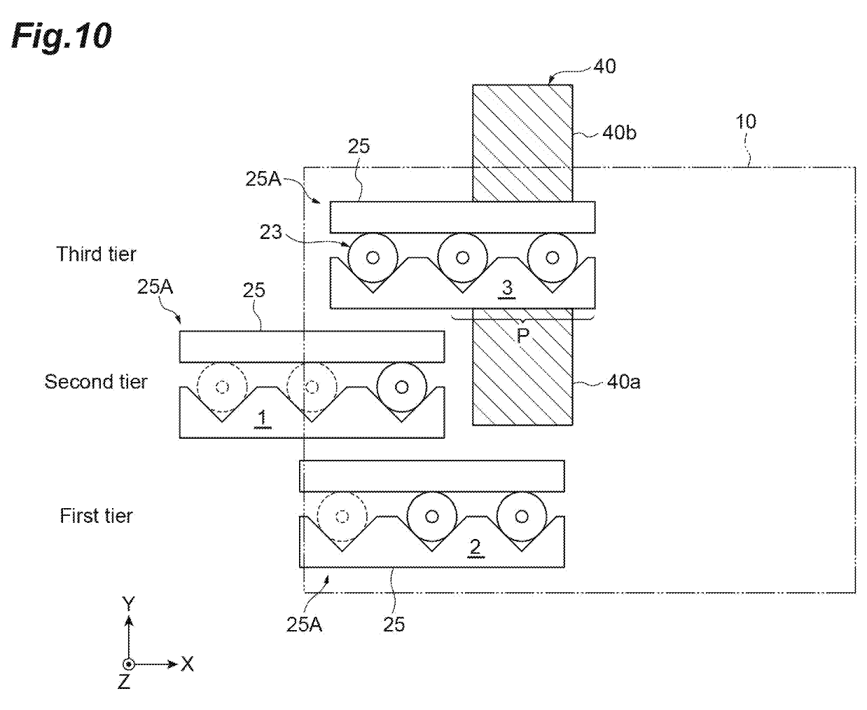

Next, as shown in FIGS. 9 and 10, the third optical fiber array 25A is arranged on the second end surface 12 of the array conversion component 10. The third optical fiber array 25A is arranged in the third tier of the N tiers, for example. Thus, the third optical fiber array 25A is arranged in a different tier from the second optical fiber array 25A. The third optical fiber array 25A is adjacent to the second optical fiber array 25A in the Y direction, and is displaced from the second optical fiber array 25A so as to protrude toward the second end 20b (see FIG. 4) in the X direction.

In a state in which the alignment component 30 is spaced apart from the first end surface 11 in the Z direction, three alignment fibers 33 are roughly positioned (roughly aligned) with respect to three optical waveguides 15 to which three optical fibers 23 included in the third optical fiber array 25A are to be connected, for example, using image processing.

Next, in a state where the third optical fiber array 25A is held by the holding tool 40, the third optical fiber array 25A is arranged at a position spaced apart from the second end surface 12 in the Z direction. As shown in FIG. 10, the holding tool 40 holds the protruding portion P of the third optical fiber array 25A protruding in the X direction with respect to the second optical fiber array 25A in the Y direction. In a state where the third optical fiber array 25A is held by the holding tool 40, three optical fibers 23 included in the third optical fiber array 25A are roughly positioned (roughly aligned) with respect to three optical waveguides 15 to be connected, for example, using image processing.

Next, the three alignment fibers 33, the three optical waveguides 15, and the three optical fiber 23 are precisely positioned with respect to each other. For example, the measurement light is incident on a first alignment fiber 33 located at the first end in the X direction among the three alignment fibers 33, a first optical waveguide 15 located at the first end in the X direction among the three optical waveguides 15, and a first optical fiber 23 located at the first end in the X direction among the three optical fibers 23. Then, the first alignment fiber 33, the first optical waveguide 15, and the first optical fiber 23 are aligned with each other so that the coupling efficiency of the measurement light is maximized (peak search alignment). Thus, the first alignment fiber 33, the first optical waveguide 15, and the first optical fiber 23 are positioned with respect to each other with high accuracy. At this time, the position of the first optical fiber 23 with respect to the array conversion component 10 is recorded.

Next, the measurement light is incident on a second alignment fiber 33 located at the second end in the X direction among the three alignment fibers 33, a second optical waveguide 15 located at the second end in the X direction among the three optical waveguides 15, and a second optical fiber 23 located at the second end in the X direction among the three optical fibers 23. Then, the second alignment fiber 33, the second optical waveguide 15, and the second optical fiber 23 are aligned with each other so that the coupling efficiency of the measurement light is maximized (peak search alignment). Thus, the second alignment fiber 33, the second optical waveguide 15, and the second optical fiber 23 are aligned with each other. At this time, the position of the second optical fiber 23 with respect to the array conversion component 10 is recorded.

Next, the recorded position of the first optical fiber 23 and the recorded position of the second optical fiber 23 are compared, and the rotation amount of the optical fiber array 25A required to align these positions with the reference position is calculated. In the case where the rotation amount is outside the allowable range, the above-described peak search alignment is performed again. When the calculated rotation amount is within the allowable range, the third optical fiber array 25A is temporarily retracted, and a predetermined amount of ultraviolet-curing adhesive is applied to the second end surface 12. Thereafter, the third optical fiber array 25A is returned to the original position (i.e., the position where the optical fiber array 25A is positioned with high accuracy).

At this time, the adhesive spreads uniformly between the second end surface 12 and the optical fiber array 25A. Thereafter, the adhesive is irradiated with ultraviolet rays for a predetermined time, whereby the adhesive is cured. As a result, the third optical fiber array 25A is fixed to the second end surface 12, and each optical fiber 23 of the third optical fiber array 25A is connected to each optical waveguide 15 to be connected. Then, the third optical fiber array 25A fixed to the second end surface 12 is released from the holding tool 40.

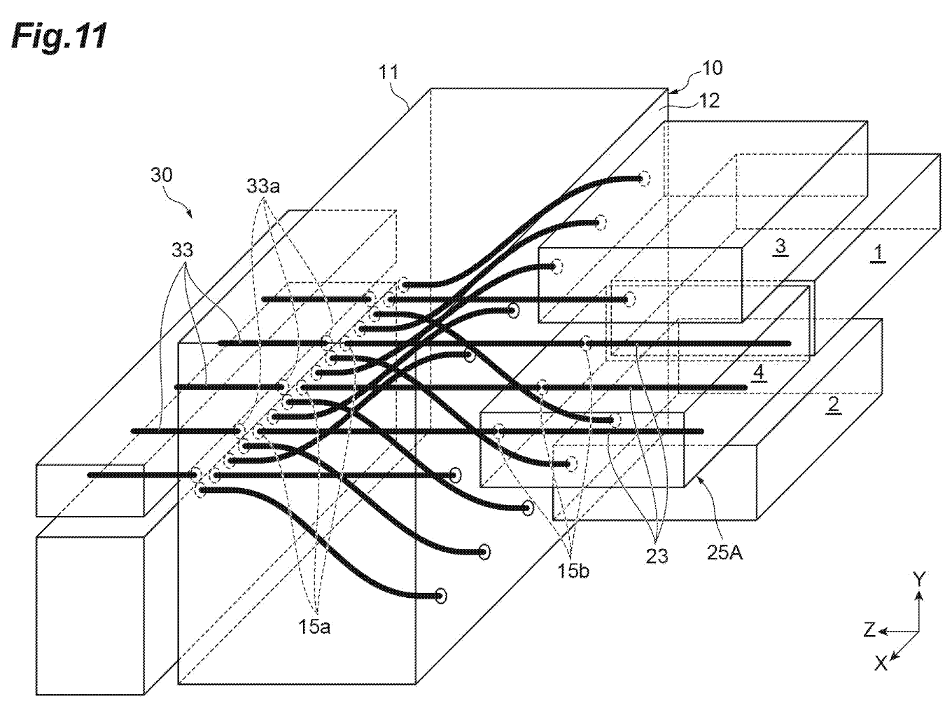

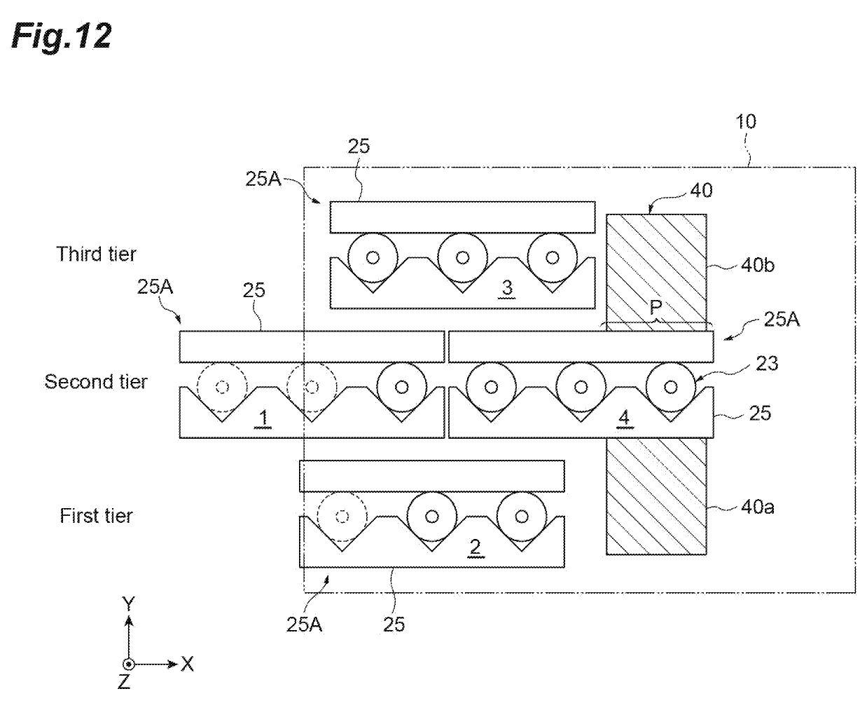

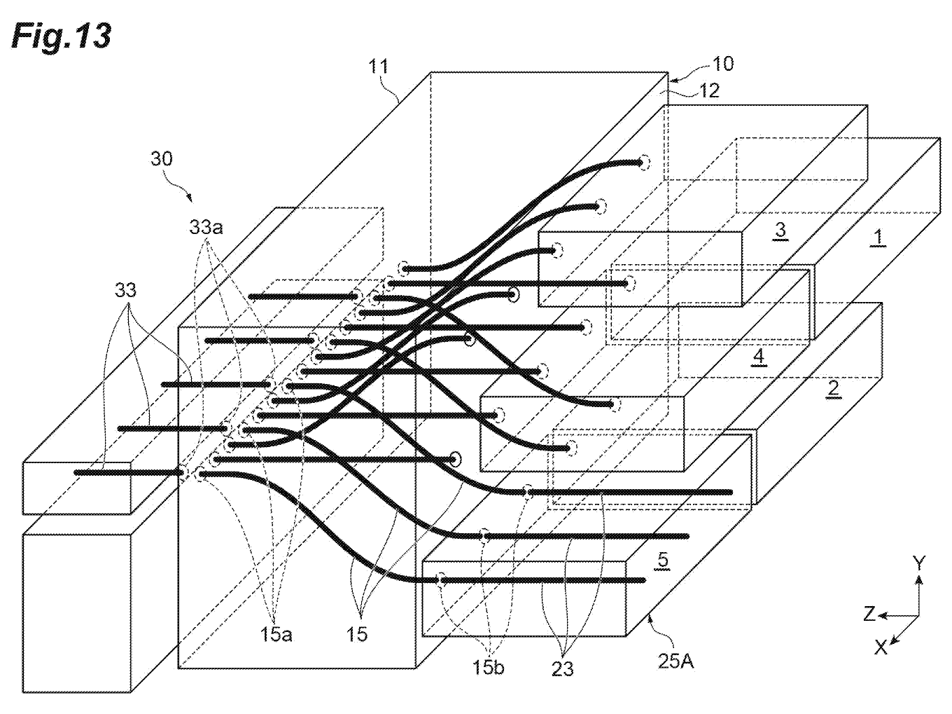

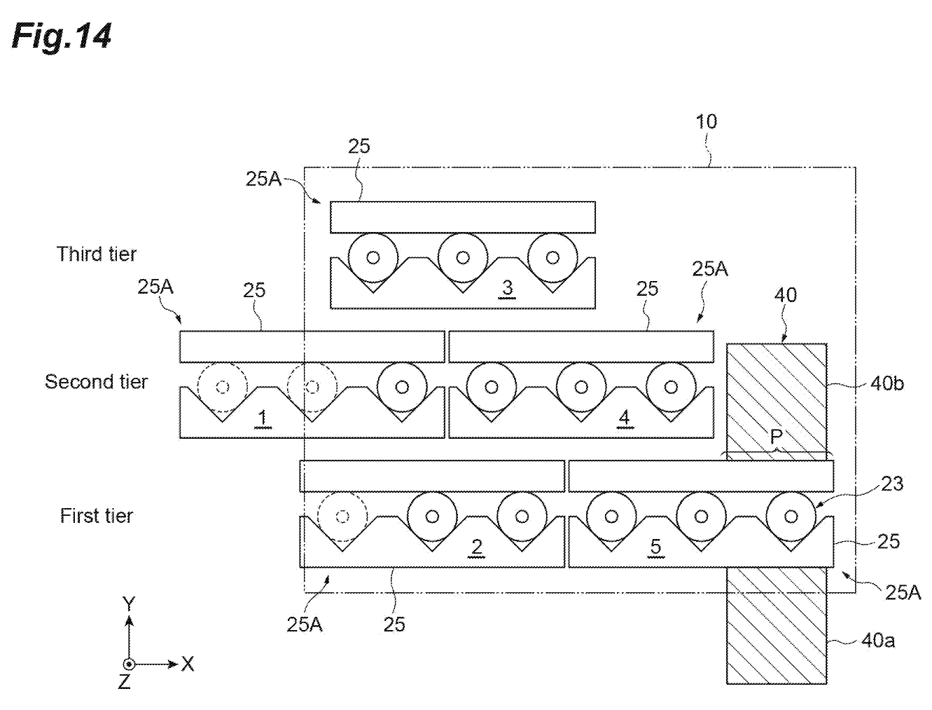

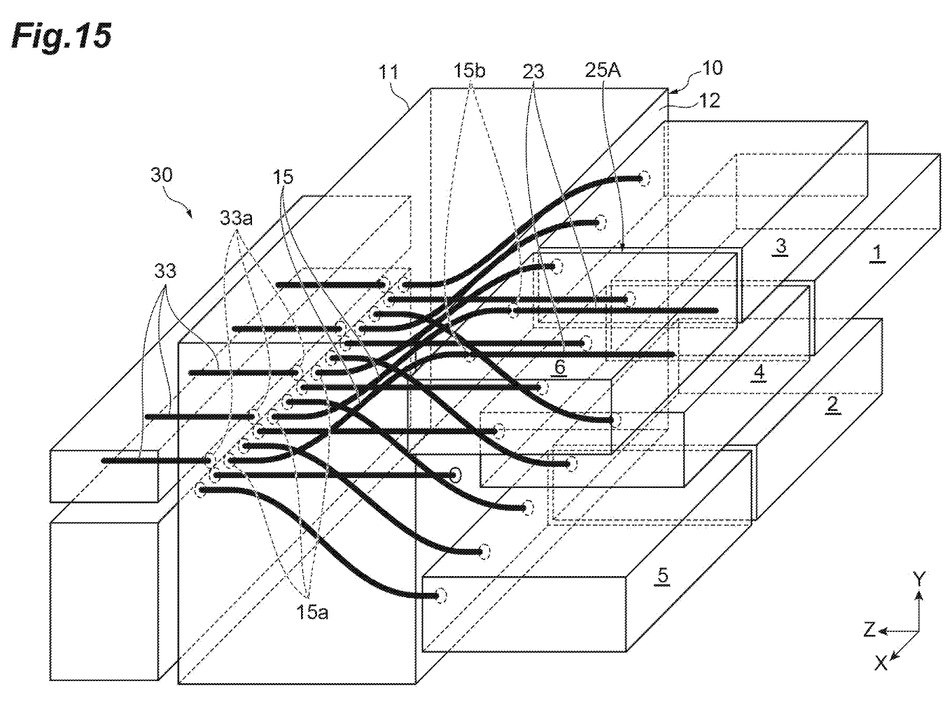

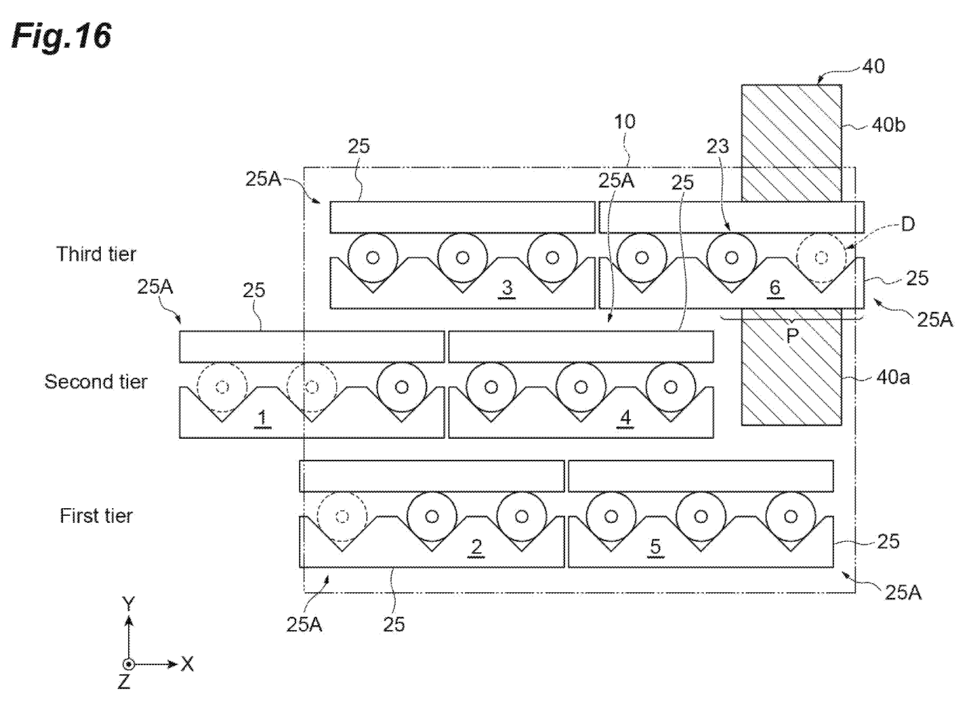

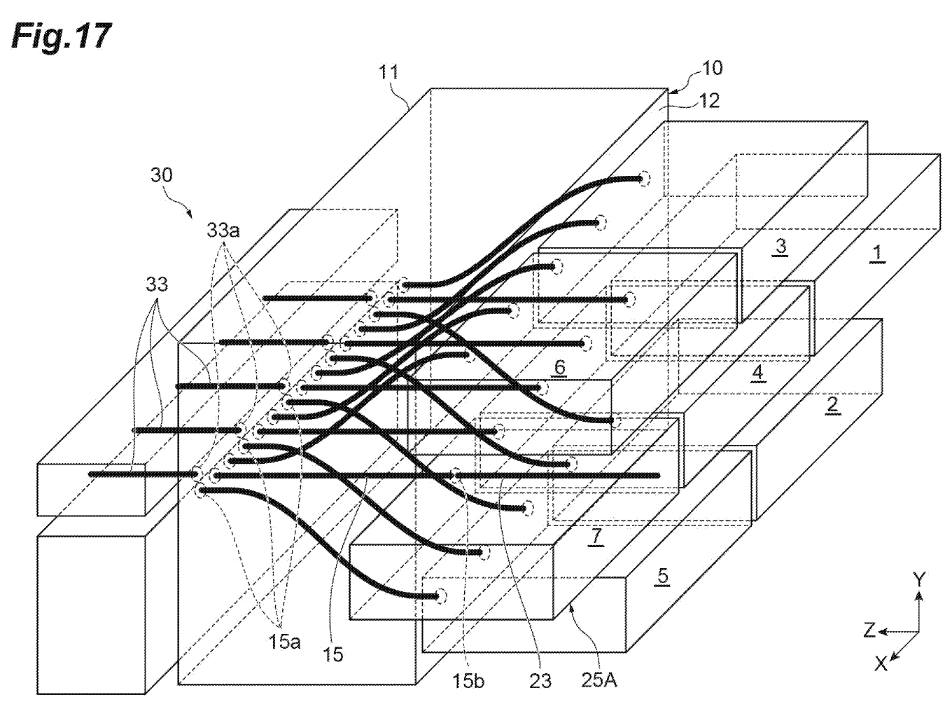

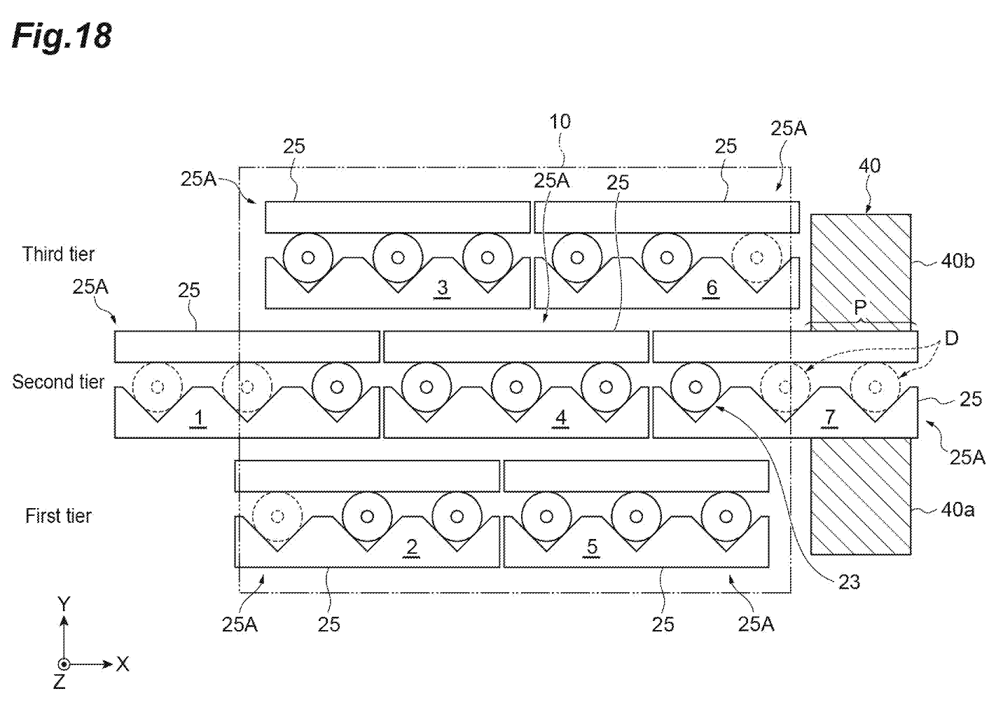

The above aligning and the connecting are performed in order for a fourth optical fiber array 25A (see FIGS. 11 and 12), a fifth optical fiber array 25A (see FIGS. 13 and 14), a sixth optical fiber array 25A (see FIGS. 15 and 16), and a seventh optical fiber array 25A (see FIGS. 17 and 18). In any optical fiber array 25A, the protruding portion P is held in the Y direction by the holding tool 40, and in this state, the aligning and the connecting are performed. Through the above steps, the optical connection assembly 1 in which all the optical fiber arrays 25A are connected to the array conversion component 10 is obtained.

The optical connection assembly 1 of the embodiment and the effect obtained by the method of manufacturing the optical connection assembly 1 will be described.

The optical connection assembly 1 of the embodiment includes the optical connection component 20 in which the optical fiber array 25A is arranged in N tiers. In this manner, when the optical fiber array 25A is arranged in N tiers, the plurality of optical fibers 23 are arrayed in both the X direction and the Y direction, and thus the width of the optical connection component 20 in the X direction can be reduced as compared with the case where the plurality of optical fibers 23 are arrayed only in the X direction. Further, in the optical connection assembly 1 of the embodiment, the center axis C of each optical fiber 23 included in the optical fiber array 25A in the n-th tier is displaced in the X direction from the center axis C of each optical fiber 23 included in the optical fiber array 25A in the corresponding (n-1)th tier. In this case, the optical fibers 23 are arranged alternately, so that the optical fibers 23 can be arranged in the X direction at a higher density. As a result, even when the pitch between the light input-output portions 5 of the connection target component 2 is made narrower, it is possible to arrange each optical fiber 23 at a pitch corresponding to the pitch between the light input-output portions 5 at a high density. Thus, it is possible to connect each optical fiber 23 of the optical connection component 20 and each light input-output portion 5 of the connection target component 2 at a high density without complicating the path of each optical waveguide 15 of the array conversion component 10. Thus, according to the optical connection assembly 1 of the embodiment, it is possible to achieve miniaturization of the optical connection assembly 1 while increasing the density of the transmission path between the optical connection component 20 and the connection target component 2.

As in the embodiment, the amount of displacement d2 in the X direction of the center axis C of each optical fiber 23 included in the optical fiber array 25A in the n-th tier from the center axis C of each optical fiber 23 included in the optical fiber array 25A of the (n-1)th tier may be smaller than the outer diameter D25 of the optical fiber 23. In this case, since the optical fibers 23 can be arranged in the X direction at a higher density, the transmission path between the optical connection component 20 and the connection target component 2 can be made denser.

As in the embodiment, the pitch (amount of displacement d1) in the X direction between the optical waveguides 15 arrayed adjacent to each other in the Y direction at the second end surface 12 may be identical to the pitch p11 in the X direction between the optical waveguides 15 at the first end surface 11. In this case, since each optical waveguide 15 of the array conversion component 10 can be formed as a planar waveguide that changes two-dimensionally (in the Y direction and the Z direction) inside the array conversion component 10, the width of the array conversion component 10 in the X direction can be made smaller while suppressing the complication of the path of each optical waveguide 15, compared to a case where a three-dimensional optical waveguide 15 is formed inside the array conversion component 10. Thus, it is possible to more reliably achieve miniaturization of the optical connection assembly 1.

As in the embodiment, the optical fiber array 25A may be arranged to be aligned in the X direction. When the optical fiber array 25A includes more optical fibers 23, the optical fiber array 25A may be lengthened in the X direction in accordance with the number of optical fibers 23. Even in this case, according to the above configuration, the optical fiber array 25A including two or more optical fibers 23 arrayed in the X direction can be formed by combining a plurality of existing retaining components 25 without newly preparing a long retaining component corresponding to the number of optical fibers 23. Thus, according to the above configuration, the optical connection assembly 1 can be manufactured at low cost using the existing retaining components 25.

As in the embodiment, among two or more optical fiber arrays 25A, the optical fiber array 25A in the n-th tier may be displaced in the X direction from the optical fiber array 25A in the (n-1)th tier adjacent to the optical fiber array 25A in the n-th tier in the Y direction. The optical fibers 23 of the optical fiber array 25A in the n-th tier may be positioned with respect to the optical waveguides 15 in a state in which the optical fiber array 25A in the n-th tier is held by the holding tool 40 so as to be displaced in the X direction from the optical fiber array 25A in the (n-1)th tier adjacent to the optical fiber array 25A in the n-th tier in the Y direction. When the optical fiber array 25A is arranged in a displaced manner, the optical fibers 23 of the optical fiber array 25A and the optical waveguides 15 of the array conversion component 10 may be easily positioned by holding the displaced portion (protruding portion P) of the retaining component 25 of the optical fiber array 25A by the holding tool 40 while avoiding interference of the holding tool 40 with the retaining component 25 of the optical fiber array 25A in a different tier.

As in the embodiment, the aligning and the connecting may be repeatedly performed such that the first optical fiber array 25A to the M-th optical fiber array 25A are sequentially held by the holding tool 40, and such that the protruding portion P of the m-th optical fiber array 25A, protruding toward the second end in the X direction with respect to the optical fiber array 25A adjacent to the m-th optical fiber array 25A in the Y direction, is held in the Y direction by the holding tool 40. As described above, the aligning and the connecting are repeated for the first to the M-th optical fiber arrays 25A such that the protruding portion P of the optical fiber array 25A is held in the Y direction by the holding tool 40, and thus it is possible to more reliably prevent the holding tool 40 holding the optical fiber array 25A from interfering with the retaining components 25 in a different tier. Thus, it is possible to more easily position the optical fibers 23 of the optical fiber array 25A and the optical waveguides 15 of the array conversion component 10.

The optical connection assembly and the method of manufacturing the optical connection assembly of the present disclosure are not limited to the above-described embodiments. The optical connection assembly and the method of manufacturing the optical connection assembly of the present disclosure may be modified in specific aspects without departing from the spirit of the claims.

For example, in the optical connection assembly described above, the case where the optical fiber array includes two or more retaining components has been described. The optical fiber array may include only one retaining component that retains one or more optical fibers. In this case, when the optical connection assembly is manufactured, in order to prevent a holding tool holding the optical fiber array in the n-th tier from interfering with the optical fiber array in a different tier, the aligning and the connecting may be performed in a state in which the side end surface of the retaining component of the optical fiber array is held in the X direction (horizontal direction) by the holding tool.

In the method of manufacturing the optical connection assembly described above, the optical fiber array at the first end of the optical connection component is a first optical fiber array, the optical fiber array at the second end of the optical connection component is an M-th optical fiber array, and the optical fibers are connected to the array conversion component in order from the first optical fiber array to the M-th optical fiber array. The order of connection to the array conversion component is not limited to this order. For example, the optical fiber array of the second end of the optical connection component is a first optical fiber array, the optical fiber array of the first end of the optical connection component is an M-th optical fiber array, and the aligning and the connecting may be performed in order from the first optical fiber array to the M-th optical fiber array.

What is claimed is:

1. An optical connection assembly comprising:
an array conversion component having a first end surface, a second end surface opposite to the first end surface, and a plurality of optical waveguides extending from the first end surface to the second end surface, the plurality of optical waveguides being arrayed in a first direction at the first end surface, an optical waveguide array being formed by two or more of the optical waveguides arrayed in the first direction at the second end surface, the optical waveguide array being arranged in N tiers (where N is an integer that is 2 or greater) in a second direction intersecting the first direction; and
an optical connection component including two or more optical fiber arrays, the two or more optical fiber arrays each including two or more optical fibers and a retaining component on which the two or more optical fibers are arrayed in the first direction, the two or more optical fibers being each connected to a corresponding one of the two or more optical waveguides, the two or more optical fiber arrays being arranged in the N tiers in the second direction,
wherein each of center axes of the two or more optical fibers included in the optical fiber array in an n-th tier (where n is an integer that is 2 or greater and that is N or less) is displaced in the first direction from a center axis of a corresponding one of the two or more optical fibers included in the optical fiber array in an (n-1)th tier.

2. The optical connection assembly according to claim 1,
wherein an amount of displacement of each of the center axes of the two or more optical fibers included in the optical fiber array in the n-th tier in the first direction from the center axis of the corresponding one of the two or more optical fibers included in the optical fiber array in the (n-1)th tier is smaller than an outer diameter of each of the optical fibers.

3. The optical connection assembly according to claim 1,
wherein a pitch in the first direction between the plurality of optical waveguides arrayed adjacent to each other in the second direction at the second end surface is identical to a pitch in the first direction between the plurality of optical waveguides at the first end surface.

4. The optical connection assembly according to claim 1,
wherein the two or more optical fiber arrays are aligned in the first direction.

5. The optical connection assembly according to claim 4,
wherein, among the two or more optical fiber arrays, the optical fiber array in the n-th tier is displaced in the first direction from the optical fiber array in the (n-1)th tier adjacent to the optical fiber array in the n-th tier in the second direction.

6. A method of manufacturing an optical connection assembly, the method comprising:
preparing an array conversion component and two or more optical fiber arrays, the array conversion component having a first end surface, a second end surface opposite to the first end surface, and a plurality of optical waveguides extending from the first end surface to the second end surface, the plurality of optical waveguides being arrayed in a first direction at the first end surface, an optical waveguide array being formed by two or more of the optical waveguides arrayed in the first direction at the second end surface, the optical waveguide array being arranged in N tiers (where N is an integer that is 2 or greater) in a second direction intersecting the first direction, the two or more optical fiber arrays each including two or more optical fibers and a retaining component on which the two or more optical fibers are arrayed in the first direction,
aligning in which, in a state in which the optical fiber array in an n-th tier (where n is an integer that is 2 or greater and that is N or less) is held at a position facing the second end surface by a holding tool, the two or more optical fibers included in the optical fiber array in the n-th tier are positioned with respect to the two or more optical waveguides in the n-th tier; and
connecting the two or more optical fibers included in the optical fiber array in the n-th tier to the two or more optical waveguides in the n-th tier by fixing the optical fiber array in the n-th tier to the second end surface in a state in which the two or more optical fibers included in the optical fiber array in the n-th tier are positioned with respect to the two or more optical waveguides in the n-th tier,
wherein the aligning and the connecting are performed repeatedly in each tier up to the N tiers to arrange the optical fiber arrays in the N tiers in the second direction such that each of center axes of the two or more optical fibers included in the optical fiber array in the n-th tier is displaced in the first direction from a center axis of a corresponding one of the two or more optical fibers included in the optical fiber array in an (n-1)th tier, thereby forming an optical connection component including the optical fiber arrays in the N tiers.

7. The method of manufacturing an optical connection assembly according to claim 6,
wherein, in the preparing,
the two or more optical fiber arrays aligned in the first direction are prepared, and
wherein, in the aligning,
the two or more optical fibers included in the optical fiber array in the n-th tier are positioned with respect to the two or more optical waveguides in a state in which the optical fiber array in the n-th tier is held by the holding tool so as to be displaced in the first direction from, among the two or more optical fiber arrays, the optical fiber array in the (n-1)th tier adjacent to the optical fiber array in the n-th tier in the second direction.

8. The method of manufacturing an optical connection assembly according to claim 7,
wherein, when the optical fiber array located at a first end of the optical connection component in the first direction is a first optical fiber array, the optical fiber array located at a second end of the optical connection component in the first direction is an M-th optical fiber array (where M is an integer that is 2 or greater), and the optical fiber array whose amount of displacement toward the second end in the first direction from the optical fiber array that is an (m-1)th optical fiber array is smallest is an m-th optical fiber array (where m is an integer that is 2 or greater and that is M or less), the aligning and the connecting are performed repeatedly such that the first optical fiber array to the M-th optical fiber array are sequentially held by the holding tool and such that a protruding portion of the m-th optical fiber array is held in the second direction by the holding tool, the protruding portion protruding toward the second end in the first direction with respect to the optical fiber array adjacent to the m-th optical fiber array in the second direction.
